(19) United States
(12) Patent Application Publication
(10) Pub. No.: US 2014/0298456 A1
(43) Pub. Date: Oct. 2, 2014

(54) SECURING APPLICATIONS FOR COMPUTING DEVICES

(71) Applicant: TATA CONSULTANCY SERVICES LIMITED, Mumbai (IN)

(72) Inventors: Rajmohan COLONEL, Bangalore (IN); Satyanarayana RAMASWAMY, Santa Clara, CA (US)

(73) Assignee: TATA CONSULTANCY SERVICES LIMITED, Mumbai (IN)

(21) Appl. No.: 14/057,087

(22) Filed: Oct. 18, 2013

(30) Foreign Application Priority Data
Mar. 28, 2013 (IN) 1235/MUM/2013

(51) Int. Cl. H04L 29/06

(52) U.S. Cl. CPC H04L 63/1408
USPC 726/22

(57) ABSTRACT

Systems and methods for securing hybrid applications for computing devices are described. According to the present subject matter, the system(s) implement the described method(s) for building and execution of secure hybrid applications. During build of the hybrid application, the disclosed method may incorporate identifying of at least one non-native file of the hybrid application, generating a primary Unique Identifier (UI) associated with the at least one non-native file, and storing the generated primary UI as a part of the hybrid application to form a secure hybrid application. During execution of the secure hybrid application the disclosed method may incorporate identifying of at least one non-native file of the secure hybrid application, generating a secondary UI associated with the at least one non-native file, extracting primary UI stored in the secure hybrid application. The system/method may further implement determining whether the generated secondary UI is different from the extracted primary UI.

### TECHNICAL FIELD

The present subject matter relates in general to securing applications for computing devices and, particularly, but not exclusively, to securing hybrid applications for computing devices.

### BACKGROUND

In today's age of information and technology, applications for computing devices have become an integral part of day to day lives of majority of users across the globe. The applications for computing devices provide a convenient platform to the users for accessing several services, such as social networking, Mobile TV, weather information, stock updates, live scores, and multimedia messaging through the computing devices. A user of a computing device has more freedom to choose and install different, latest, and updated applications on his computing device from various sources, thereby customizing the computing device experience.

Application development on operating system platforms of computing devices has wide divergence due to large diversity of available operating systems. Generally, the operating systems include Android™, iOS™, Windows Mobile®, Symbian™ OS, BlackBerry® OS, Palm OS®, etc. Single platform application development limits the reach of a computing device application and creates platform lock-in, increasing time and resources required to adapt to a different platform. Whereas cross-platform application development extends the reach of applications for computing devices by being able to be deployed to more than one computing device platform, such as iOS™, BlackBerry® OS, and Android™. This, results in an ability to change course of the applications as computing device platforms continue to evolve and reach a substantially larger pool of users.

Hybrid applications are a type of cross-platform applications which combine the convenience of developing applications for computing devices with platform-independent web technologies, such as HyperText Markup Language (HTML), JavaScript, and Cascading Style Sheet (CSS), and the benefits of platform-specific applications.

### BRIEF DESCRIPTION OF THE FIGURES

The detailed description is described with reference to the accompanying figures. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 schematically illustrates a hybrid application system, according to an embodiment of the present subject matter;

FIG. 2 illustrates a method for securing hybrid applications, according to an embodiment of the present subject matter;

FIG. 3 illustrates a method for executing a secure hybrid application, according to an embodiment of the present subject matter;

It should be appreciated by those skilled in the art that any block diagram herein, represent conceptual views of illustrative systems embodying the principles of the present subject matter. Similarly, it will be appreciated that any flow charts, flow diagrams, and the like represent various processes which may be substantially represented in computer readable medium and so executed by a computer or processor, whether or not such computer or processor is explicitly shown.

### DETAILED DESCRIPTION

Systems and methods for securing applications for computing devices, is described herein. The methods can be implemented in various computing devices building and executing hybrid applications. Although the description herein is with reference to hybrid applications, the methods and systems may be implemented in other cross-platform applications vulnerable to malware attacks, albeit with a few variations, as will be understood by a person skilled in the art.

Hybrid applications typically comprise a platform-independent component which is independent of the platform of the computing device. The hybrid application may also include a platform-specific component which is dependent on the platform of the computing device. The hybrid application may further include an abstraction layer such as, WinJS and Apache Cordova, that may be utilized by either of the other components. For sake of explanation, the platform-independent component is referred to as non-native component and the platform-specific component is referred to as native component, hereinafter. It would be understood that the non-native component may comprise one or more non-native files and similarly native component may comprise one or more native files.

In a hybrid application, the non-native component is generally developed using web technologies, such as HyperText Markup Language (HTML), JavaScript, and Cascading Style Sheet (CSS). The non-native component is packaged with the native component, where the native component acts as a shell for the non-native component and extends the benefits of the web technologies to the non-native component. The native component acts as a proxy that allows non-native component to access a wide range of device Application Program Interfaces (APIs) and device hardware capabilities, such as sensors, not normally available in an application which is completely non-native and based on only web technologies. With hybrid applications, developers can use native components to customize the look and feel of the hybrid application and use non-native components to help overcome the update limitations of native applications.

Typically, the non-native files of the hybrid application, such as HTML and JavaScript files are easily readable. Hence the non-native files can be easily tampered, making the non-native component vulnerable as compared to the native component. In a situation when the hybrid application is deployed on a computing device, a malware can easily tamper the non-native component. In such situations, when the hybrid application is run, the hybrid application may load and execute the tampered non-native component, which may cause the hybrid application to execute malicious logic, injected into the non-native component, by the malware. Hence making the hybrid applications vulnerable to malicious attacks.

In accordance of an implementation of the present subject matter, systems and methods for securing hybrid applications for computing devices are described herein. On one hand, the described techniques provide security to hybrid applications; on the other, also provide a secure mechanism to determine tampered hybrid application to restrict any un-indented or malicious activity.

In an implementation of the present subject matter, non-native file associated with the hybrid application is identified. As described earlier, the non-native files may be platform-independent and built with one or more the web technologies. In said implementation, a Unique Identifier (UI) associated with the non-native file identified is generated. The UI may be understood by those skilled in the art as a unique hash value or hash string corresponding to content of the non-native files which when generated for different non-native files, is a different and unique value. The UI generated during a build phase of the hybrid application is referred to as a primary UI. Further, the primary UI is stored as a part of the hybrid application to generate a secure hybrid application. In one implementation, the stored UI can be used to perform integrity check of the non-native files, once the secure hybrid application is to be executed.

In an implementation of the present subject matter, while execution of the secure hybrid application, the non-native files associated with the secure hybrid application are identified. Once identified, a secondary UI may be generated for the corresponding identified non-native files. Further, the primary UI stored as a part of the secure hybrid application may also be extracted.

The primary UI may then be compared with the generated secondary UI. In a situation where the extracted primary UI is different from the generated secondary UI, it is derived that the contents of the non-native file have been modified after the build of the secure hybrid application. Since the modification can be due to intrusion of a malware and the non-native files could have been tampered, an alert of intrusion may be provided indicating a possible tamper. Whereas, in situation where the extracted primary UI is not different from the generated secondary UI, it is derived that no non-native file of the secure hybrid application has been modified after the build of the secure hybrid application. This provides the integrity check for the non-native files of the secure application.

In an implementation, while executing the secure hybrid application integrity check for the non-native file is performed. The integrity check reveals if the non-native component of the secure hybrid application has been modified. Depending on whether the secure hybrid application has been modified or not, further actions, such as continuing the secure hybrid application execution, preventing the functions of the secure hybrid application from further execution, and providing notification to an user of the secure hybrid application, can be performed. The performing of integrity check, determining whether the secure hybrid application has been modified or not, and taking actions based on the determination will provide security to the secure hybrid application from any malicious content which may be added in to the non-native files of the secure hybrid applications.

It should be appreciated that an embodiment of this disclosure can be implemented in numerous ways, including as a system, a device, a method, a computer readable medium, such as a computer readable storage medium containing computer readable instructions, or as a computer program product comprising a computer usable medium having a computer readable instructions embodied therein. One will appreciate that the computing device described herein may include any computer or computing device running an operating system for use on handheld or mobile devices, such as smartphones, personal digital assistants (PDAs), tablets, mobile phones, and the like. For example, a computing device may include devices, such as Apple iPhone®, Apple iPad®, Palm Pre™, or any device running Apple iOS™, Android™ OS, Google Chrome™ OS, Symbian OS®, Windows Mobile® OS, Palm OS® or Palm Web OS™.

It should also be noted that the description merely illustrates the principles of the present subject matter. It will thus be appreciated that those skilled in the art will be able to devise various arrangements that, although not explicitly described herein, embody the principles of the present subject matter and are included within its spirit and scope. Furthermore, all examples recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

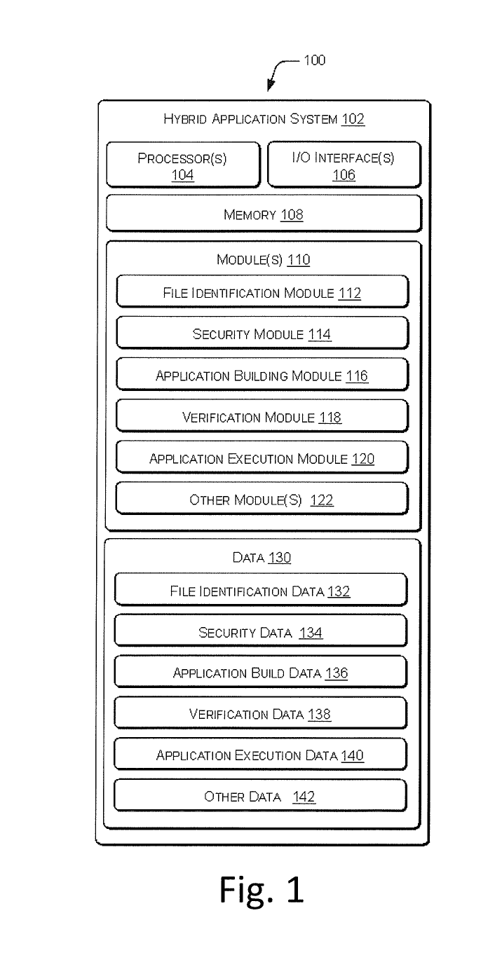

The manner in which the systems and methods of present subject matter shall be implemented has been explained in details with respect to the FIGS. 1-3. While aspects of described systems and methods for securing hybrid applications for computing devices can be implemented in any number of different computing systems, computing frameworks, computing devices, and/or configurations, the embodiments are described in the context of the following exemplary systems and implementations.

FIG. 1 schematically illustrates different components of a hybrid application system 102 for securing hybrid applications, according to an implementation of the present subject matter. The hybrid application system 102 described herein, can be implemented in/as any computing device, comprising a variety of devices including, but not limited to, a stationary computing device, such as a desktop computer, a workstation, a multiprocessor system, a network computer, a minicomputer, and a server; and a mobile computing device, such as a hand-held device, a mobile phone, a personal digital assistant (PDA), a smart phone, a laptop computer, and a tablet.

The hybrid application system 102 includes one or more processor(s) 104. The processor(s) 104 can be a single processing unit or a number of units, all of which could include multiple computing units. The processor(s) may be implemented as one or more microprocessors, microcomputers, microcontrollers, digital signal processors, central processing units, state machines, logic circuitries, and/or any devices that manipulate signals based on operational instructions. Among other capabilities, the processor(s) are adapted to fetch and execute computer-readable instructions stored in the memory. The memory may include any computer-readable medium known in the art including, for example, volatile memory, such as SRAMs and DRAMs and/or non-volatile memory, such as EPROMs and flash memories.

The hybrid application system 102 includes one or more I/O interface(s) 106 coupled to the processor(s) 104. The I/O interface(s) 106 may include a variety of software and hardware interfaces, for example, interfaces for peripheral device(s), such as a keyboard, a mouse, and an external memory. Further, the I/O interfaces 106 may facilitate multiple communications within a wide variety of protocol types including, operating system to application communication, inter process communication, etc.

The hybrid application system 102 may include memory 108 coupled to the processor(s) 104, wherein the memory 108 can include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

Further, the hybrid application system 102 may include module(s) 110. The modules 110 may be coupled to the processor(s) 104. The modules 110, amongst other things, include routines, programs, objects, components, data structures, etc., which perform particular tasks or implement particular abstract data types. The modules 110 may also be implemented as, signal processor(s), state machine(s), logic circuitries, and/or any other device or component that manipulate signals based on operational instructions.

In another aspect of the present subject matter, the modules 110 may be computer-readable instructions which, when executed by a processor/processing unit, perform any of the described functionalities. The machine-readable instructions may be stored on an electronic memory device, hard disk, optical disk or other machine-readable storage medium or non-transitory medium. In one implementation, the computer-readable instructions can be also be downloaded to a storage medium via a network connection.

In an implementation, the module(s) 110 includes a file identification module 112, a security module 114, an application building module 116, a verification module 118, an application execution module 120, and other module(s) 122. The other module(s) 122 may include programs or coded instructions that supplement applications or functions performed by the system 102.

The hybrid application system 102 may further include data 130. The data 130 may be coupled to the processor(s) 104. In an implementation, the data 130 includes file identification data 132, security data 134, application build data 136, verification data 138, application execution data 140, and other data 142. The other data 142 amongst other things, may serve as a repository for storing data that is processed, received, or generated as a result of the execution of one or more modules in the module(s) 110. Although the data 130 is shown internal to the system 102, it may be understood that the data 130 can reside in an external repository (not shown in the figure), which may be coupled to the hybrid application system 102. The hybrid application system 102 may communicate with the external repository through the I/O interface(s) 106 to obtain information from the data 130.

The number of the described modules and data in which the hybrid application system 102 is described is not intended to be construed as a limitation, and any number of the described modules and data components can be combined in any suitable format to implement the respective module and data component, or any alternative modules and data components. Additionally, individual modules and data components may be eliminated from the system without departing from the spirit and scope of the subject matter described herein. Furthermore, the modules can be implemented in any suitable hardware, software, firmware, or combination thereof.

In an implementation of the present subject matter, the file identification module 112 of the hybrid application system 102, is adapted to identify non-native files associated with a hybrid application. In an implementation the file identification module 112 may identify the non-native files during the application build phase. The non-native files may be identified as the files which are platform implementation independent and allow the hybrid application to utilize integrated web technologies. In said implementation, the file identification module 112 is adapted to identify the non native files based on file parameters which may be stored in the file identification data 132. The file parameters may comprise all possible extensions for the non-native files. In an implementation the non-native files are identified based on identifying files with web technology extensions, such as .css, .js, and .html. In another implementation all the native files of hybrid application could be excluded to identify the non-native files of the hybrid application.

In an implementation of the present subject matter, the security module 114 is adapted to generate a primary unique identifier (UI) for the non-native files identified by the file identification module 112. In said implementation, the primary UI may be a mathematical scheme or a hash value for demonstrating the integrity of the non-native files. The security module 114 may implement an algorithm, such as Message-Digest Algorithm (MDA), Cyclic Redundancy Check (CRC), and Secure Hash Algorithm (SHA), to generate the UI. In an implementation the security module 114 is adapted to generate the primary UI for the non-native files during the application build phase. It would be appreciated that the security module 114 may generate the primary UI for merely a sub set of identified non-native files, depending on various factors, including but not limited to, file priority, file susceptibility, file size, file significance, and the like.

In an implementation of the present subject matter, the application building module 116 is adapted to build the hybrid application. The hybrid application may be built by adding necessary native files to the non-native files to facilitate the desired functioning of the hybrid application. The native files added may depend on the computing device platform, such as software platform, of the computing device where the hybrid application will be used. The application building module 116 may store the generated primary UI as a part of the hybrid application. In said implementation the generated primary UI may be stored as a part of native files of the hybrid application. Since the native files are less susceptible to tampering, an outreach of a malware to tamper the UI associated with the non-native files may be reduced. However in another implementation the generated primary UI may be stored as a part of non-native files of the hybrid application. The primary UI may be stored in the form of variables. For the purpose of clarity, the hybrid application comprising the stored primary UI is referred to as a secure hybrid application.

The application building module 116 may also include a security mechanism into the hybrid application. The security mechanism may be a set of instructions to follow a procedure during the execution of the secure hybrid application. The procedure may comprise the identification of non-native files of the secure hybrid application. The procedure may further comprise generating a secondary UI associated with the identified non-native files. In one implementation of the present subject matter, the secondary UI is generated based on the same technique that had been utilized by the security module 114 to generate the primary UI. For example, the secondary UI may be generated based on SHA technique in situations where the primary UI was generated based on the similar SHA technique.

In said implementation, the procedure may further comprise the step of extracting the stored primary UI and comparing the extracted primary UI with the generated secondary UI.

The procedure of security mechanism included by the application building module 116 may further comprise decision taking and execution step depending on if the generated secondary UI is different from the extracted primary UI. In situation when the generated secondary UI is not different from the extracted UI the procedure may allow continued execution of the secure hybrid application. Whereas in situation where the generated secondary UI is different from the extracted primary UI, the procedure may include mechanism to perform at least one of preventing secure hybrid application from further execution, generating a notification to notify that the generated secondary UI is different from the extracted primary UI, and performing an user task.

The notification may be in various forms, such as notifying user of the secure hybrid application to update the secure hybrid application, notifying user of the secure hybrid application to uninstall the secure hybrid application, notifying user of the secure hybrid application to reinstall the secure hybrid application, take the user to application store to perform a user task. The user task may be one or more of uninstalling, updating, and reinstalling the secure hybrid application. The notifying may be performed by one of, but not limited to, displaying at least one text message, providing at least one audio message, providing at least one multimedia message, and taking to application store.

In an implementation of the present subject matter, the verification module 118 is adapted to perform integrity check of the secure hybrid application. The verification module 118 may be adapted to extract the stored primary UI from the secure hybrid application. The verification module 118 may also receive the generated secondary UI from the security module 114. In said implementation, the verification module 118 may further be adapted to compare the extracted primary UI and generated secondary UI to verify the integrity of the secure hybrid application. In scenarios where the secure hybrid application has been tampered with, the generated secondary UI will be different from the extracted primary UI, and are identified by the verification module 118.

In another implementation of the present subject matter, the application execution module 120 is adapted to run the secure hybrid application. The application execution module 120 may call upon the file identification module 112 to identify non-native file of the secure hybrid application. The application execution module 120 may then call the security module 114 to generate a secondary UI associated with the identified non-native files. The application execution module 120 may then call the verification module 118 to perform integrity check whether the generated secondary UI is different from the extracted primary UI. The application execution module 120 may then perform some task, such as continuing execution of the secure hybrid application, preventing further execution of the secure hybrid application and provide notification to the user of secure hybrid application based on the result of the integrity check performed by the verification module 118.

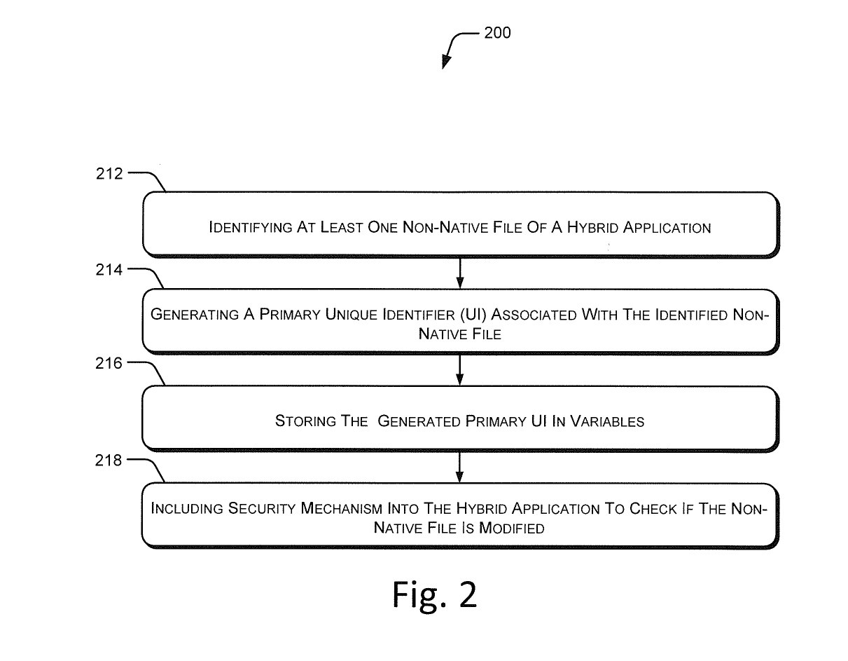

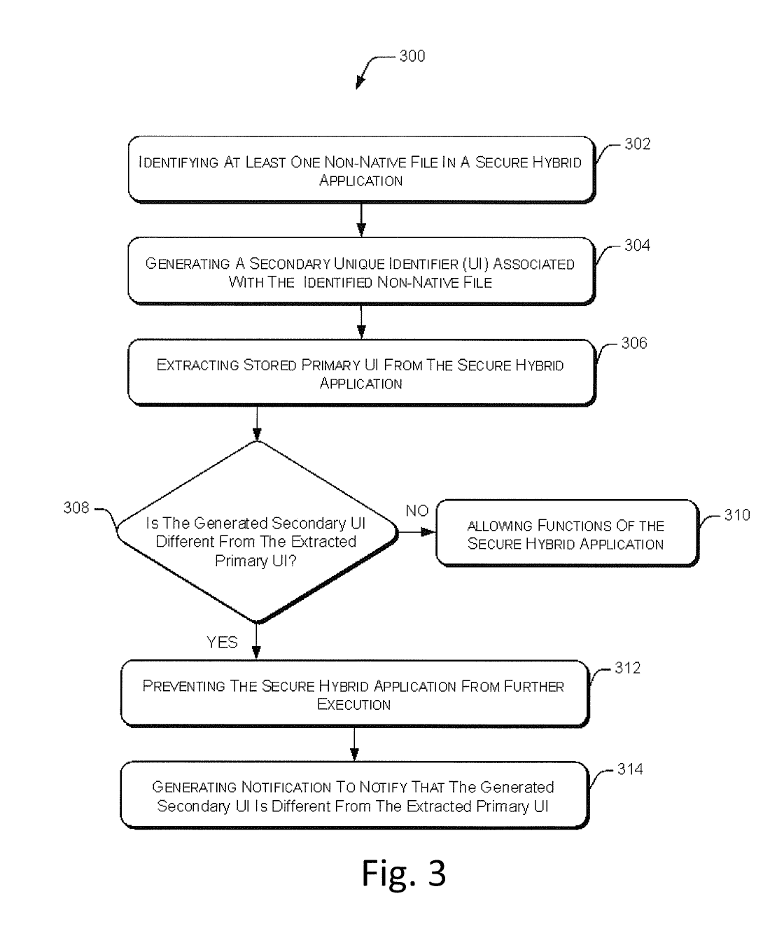

FIG. 2 and FIG. 3 illustrate, methods 200 and 300 for securing hybrid applications for computing devices, according to an implementation of the present subject matter. The number of the described method blocks in which the methods 200 and 300 are described is not intended to be construed as a limitation, and any number of the described method blocks can be combined in any suitable order to implement the respective method, or any alternative methods. Additionally, individual blocks may be deleted from the method without departing from the spirit and scope of the subject matter described herein. Furthermore, the methods can be implemented in any suitable hardware, software, firmware, or combination thereof.

The method(s) may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

A person skilled in the art will readily recognize that steps of the methods can be performed by programmed computers. Herein, some embodiments are also intended to cover program storage devices, for example, digital data storage media, which are machine or computer readable and encode machine-executable or computer-executable programs of instructions, where said instructions perform some or all of the steps of the described method. The program storage devices may be, for example, digital memories, magnetic storage media, such as a magnetic disks and magnetic tapes, hard drives, or optically readable digital data storage media. The embodiments are also intended to cover both communication network and communication devices adapted to perform said steps of the exemplary methods.

FIG. 2 illustrates an exemplary method of a procedure followed by hybrid application system when implemented in a hybrid framework. The hybrid framework may be any computing device or a system, capable of building a hybrid application.

Referring to FIG. 2, at block 212, non-native file of a hybrid application are identified. As described earlier the non-native files may include components of the hybrid application written using web technologies.

At block 214, a primary UI associated with the identified non-native files is generated. Methodologies, such as MDA, CRC, and SHA, may be used to generate the UI.

At block 216, the primary UI is stored. The primary UI may be stored in variables. In one implementation of the present subject matter, the primary UI may be included in to the hybrid application to form a secure hybrid application.

At block 218, security mechanisms are included into the hybrid application. The security mechanisms include methodology or procedure to check if the non-native files of secure hybrid applications are modified at a later stage after the building of the secure hybrid application. The security mechanism may also include further actions to be taken based on the verification carried out by checking. The step to check if the non-native files of secure hybrid applications are modified or not may be performed by generating the secondary UI for non-native files identified during run time of application, by following the same procedure as in the application build time, and comparing it with the stored primary UI of the secure hybrid application.

FIG. 3 illustrates an exemplary method of a procedure followed by a computing device, when execution of a secure hybrid application is initiated.

Referring to FIG. 3, at block 302, non-native file associated with the secure hybrid application are identified. As described earlier the non-native files may include components of the secure hybrid application written using web technologies.

At block 304, a secondary UI associated with the identified non-native files is generated. Methodologies, such as MDA, CRC, and SHA, may be used to generate the secondary UI. It would be appreciated that the technique used to generate the primary UI during the build phase of the secure hybrid application may be used to generate the secondary UI.

At block 306, the primary UI stored within the secure hybrid application is extracted. In one implementation, the extracted primary UI represents a unique value corresponding to the content of the non-native files, when being developed for the secure hybrid application. As described earlier, the stored primary UI may be extracted from the variable in which it is stored.

At block 308, the extracted primary UI is compared with the generated secondary UI. The comparison may be done, to check if the generated secondary UI is different from the extracted primary UI. In case if the secure hybrid application has been modified or tampered with in any way, the generated secondary UI will be different from the extracted primary UI. Hence, based on the comparison of the primary UI with the secondary UI may allow a detection of any kind of tampering with the secure hybrid application.

In case when the generated secondary UI is not different from the extracted primary UI, the control flows to step 310 (‘NO’ branch). However, in case when the generated secondary UI is different from the extracted primary UI, the control flows to step 312 (‘YES’ branch).

At step 310, the execution of the secure hybrid application may be allowed. It would be appreciated that the execution of the secure application may be allowed since the determination at step 308 identifies no potential tampering of the non-native files of the secure hybrid application.

At step 312, the execution of the secure hybrid application may be prevented. It would be appreciated that the execution of the secure application may be prevented since the determination at step 308 identifies potential tampering of the non-native files of the secure hybrid application.

At step 314, a notification is generated to notify a possible tampering with the non-native files of the secure hybrid application. Since the generated secondary UI has been identified to be different from the extracted primary UI, at step 308, a potential tampering may be identified and the notification may be generated. In one implementation, the notification may be generated in various forms, such as notifying user of the secure hybrid application to update the secure hybrid application, notifying user of the secure hybrid application to uninstall the secure hybrid application, notifying user of the secure hybrid application to reinstall the secure hybrid application, and take the user to application store to perform a user task. The user task may be one or more of uninstalling, updating, and reinstalling the secure hybrid application.

In an implementation of the present subject matter, the secure hybrid application itself may comprise a secure mechanism adapted to perform steps shown in method 300. In another implementation the steps of method 300 may be followed while executing a secure hybrid application.

Although the disclosed subject matter has been described with reference to particular means, materials, and embodiments, the disclosed subject matter is not intended to be limited to the particulars disclosed; rather, the subject matter extends to all functionally equivalent structures, methods, and uses such as are within the scope of the appended claims.

I/We claim:

1. A method for securing a hybrid application, the method comprising:
identifying at least one non-native file associated with the hybrid application, wherein the non-native file is platform-independent and built with at least one of web technologies;
generating a primary Unique Identifier (UI) associated with the at least one non-native file, wherein the primary UI is indicative of a unique value associated with contents of the at least one non-native file; and
storing the generated primary UI as a part of the hybrid application to generate a secure hybrid application.

2. The method as claimed in claim 1, wherein the identifying is based on file parameters, and wherein the file parameters comprises at least extension of the at least one non-native file.

3. The method as claimed in claim 1, wherein the generating is based on one of Message-Digest Algorithm (MDA), Cyclic Redundancy Check (CRC), and Secure Hash Algorithm (SHA).

4. The method as claimed in claim 1, wherein the generating of the primary UI is for each of the at least one non-native file.

5. The method as claimed in claim 1, wherein the storing is in at least one of native file of the hybrid application and non-native file of the hybrid application.

6. The method as claimed in claim 1 further comprising, including a security mechanism into the hybrid application, wherein the security mechanism is adapted to:
identify at least one non-native file associated with the hybrid application;
generate a secondary UI associated with the at least one non-native file;
extract the primary UI stored as a part of the hybrid application; and
determine whether the generated secondary UI is different from the extracted primary UI.

7. The method as claimed in claim 1 further comprising:
identifying the at least one non-native file associated with the secure hybrid application;
generating a secondary UI associated with the at least one non-native file, wherein the generated secondary UI is indicative of a unique value associated with contents of the at least one non-native file;
extracting the primary UI stored as a part of the secure hybrid application; and
comparing the primary UI and the secondary UI to determine whether the generated secondary UI is different from the extracted primary UI.

8. The method as claimed in claim 7 further comprising, allowing execution of the secure hybrid application, wherein the generated secondary UI is same as the extracted primary UI.

9. The method as claimed in claim 7, the method further comprising preventing the secure hybrid application from further execution, wherein the generated secondary UI is different from the extracted primary UI.

10. The method as claimed in claim 9 further comprising, at least one of notifying an user of the secure hybrid application, that the secure hybrid application has been modified; and notifying the user to perform a user action.

11. The method as claimed in claim 10, wherein the notifying comprises at least one of, displaying at least one text message, providing at least one audio message, providing at least one multimedia message, and guiding to an application store.

12. The method as claimed in claim 10, wherein the user action is one of updating the secure hybrid application, uninstalling the secure hybrid application, and re-installing the application.

13. A hybrid application system for securing a hybrid application, the hybrid application system comprising:
a processor;
a file identification module coupled to the processor, adapted to identify at least one non-native file associated with the hybrid application, wherein the non-native file is platform-independent and built with at least one of web technologies;
a security module coupled to the processor, adapted to generate a primary UI associated with the at least one non-native file, wherein the primary UI is indicative of a unique value associated with contents of the at least one non-native file; and
an application building module coupled to the processor, adapted to store the generated primary UI as a part of the hybrid application to generate a secure hybrid application.

14. The hybrid application system as claimed in claim 13, wherein the file identification module identifies the at least one non-native file based on file parameters, and wherein the file parameters comprises at least extension of the at least one non-native file.

15. The hybrid application system as claimed in claim 13, wherein the security module generates the primary UI based on one of Message-Digest Algorithm (MDA), Cyclic Redundancy Check (CRC), and Secure Hash Algorithm (SHA).

16. The hybrid application system as claimed in claim 13, wherein the security module generates the primary UI for each of the at least one non-native files.

17. The hybrid application system as claimed in claim 13, wherein the application building module stores the generated primary UI in at least one of native file of the hybrid application and non-native file of the hybrid application.

18. The hybrid application system as claimed in claim 13, wherein the application building module is further adapted to:
identify at least one non-native file associated with the secure hybrid application, wherein the non-native file is platform-independent and built with at least one of web technologies;
generate a secondary UI associated with the at least one non-native file, wherein the generated secondary UI is indicative of a unique value associated with contents of the at least one non-native file;
extract the primary UI stored as a part of the secure hybrid application; and
compare the primary UI and the secondary UI to determine whether the generated secondary UI is different from the extracted primary UI.

19. A non-transitory computer readable medium having a set of computer readable instructions that, when executed, cause a computing system to:
identify at least one non-native file associated with a secure hybrid application, wherein the non-native file is platform-independent and built with at least one of web technologies;
generate a secondary UI associated with the at least one non-native file, wherein the generated secondary UI is indicative of a unique value associated with contents of the at least one non-native file;
extract a primary UI stored as a part of the secure hybrid application; and
compare the primary UI and the secondary UI to determine whether the generated secondary UI is different from the extracted primary UI.

20. The non-transitory computer readable medium as claimed in claim 19, having the set of computer readable instructions that, when executed, cause the computing system to:
identify the at least one non-native file associated with a hybrid application;
generate the primary Unique Identifier (UI) associated with the at least one non-native file, wherein the primary UI is indicative of a unique value associated with contents of the at least one non-native file; and
store the generated primary UI as a part of the hybrid application to generate the secure hybrid application.
